(19) United States
(12) Patent Application Publication
(10) Pub. No.: US 2006/0101707 A1
(43) Pub. Date: May 18, 2006

(54) Trash-can and dumpsters pest eliminator

(76) Inventor: Timothy Allan James, Carson, CA (US)

Correspondence Address: Timothy A. James, 20028 Tajauta Ave, Carson, CA, 90746, US

(21) Appl. No.: 10/933,194

(22) Filed: Nov. 18, 2004

(51) Int. Cl. A01M 1/20; A01M 13/00

(52) U.S. Cl. 43/132.1; 43/125

(57) ABSTRACT

The “Trashcan and Dumpster Pest Eliminator” for small or large trashcans, has a double side adhesive strip on it's top to attack it. It is made out of a plastic 3-inch round 1-inch whit bowl disc shape with vents.

For dumpsters it's a 6-inch by 3½ inch and 1-inch whit ob-long shape with vents. It will hold inside a sponge like material treated with insect killing chemicals. When pulling down on the “Trashcan and Dumpster Pest Eliminator” it snaps open its vents and lock into place and the sweet aroma vapors fills down and effectively kills the insects inside of the trashcan or dumpsters. On the tops is a clip also made of plastic that when you twist it to the left, you install and to the right to remove so it can be refilled when needed.

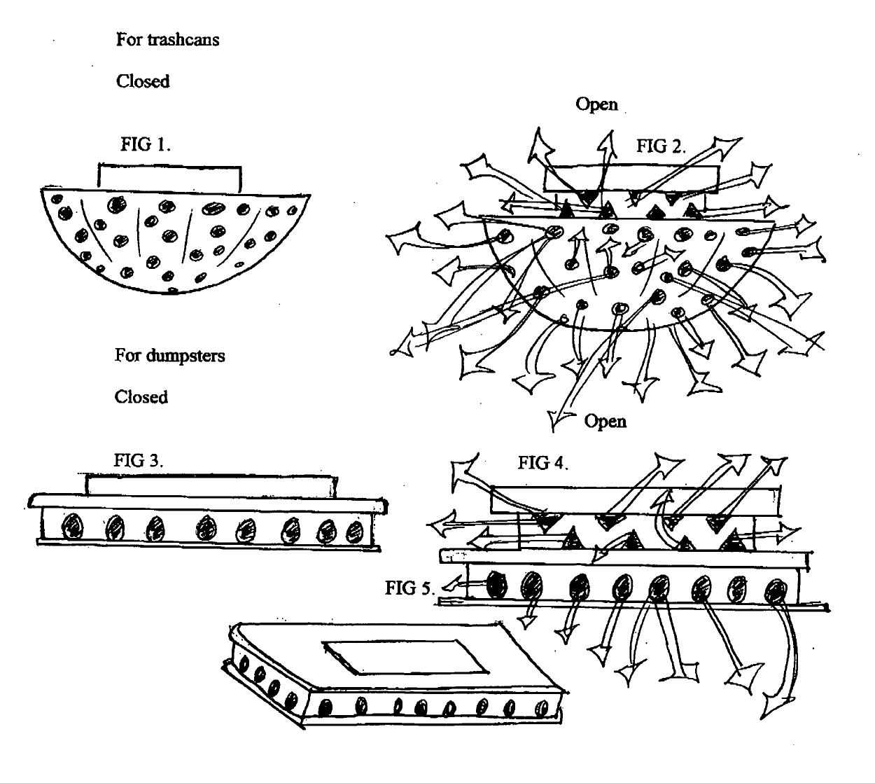

FIG. 1. Shows the trashcan device closes When closed, the device is not in use.

FIG. 2. Shows the trashcan device open, clearly showing the vented holes on the head and base of the device.

The arrows show the direction of the chemical treated material disbursing deadly vapours throughout the trashcan killing the trapped insects.

It also shows vented hole on the base large enough to trap flying or crawling insects inside.

FIG. 3. Shows the dumpster device closed. All though the vented holes appear to be open, they are not and the device is not in use.

FIG. 4. Shows the device open. The arrows show the direction of the chemical treated material disbursing deadly vapours throughout the dumpster killing the trapped insects inside.

It also shows vented holes on the base and head large enough to trap flying or crawling its inside.

FIG. 5. Shows the closed device with an adhesive strip on the top.

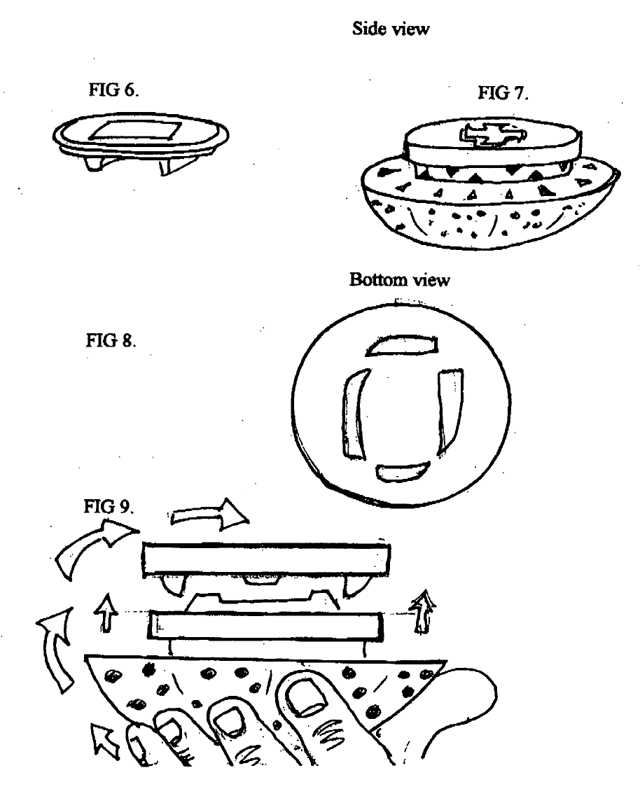

FIG. 6. Shows the side view of the top bracket device with adhesive tape.

FIG. 7. Shows the many-vented holes in the device with bracket on top.

When the top device is attached to the top of a trashcan, the trashcan device Is inserted into the top bracket they inter lock with a twist holding the device in place.

The reason the top bracket device is put into place first, is to makes it easier to install new refills.

FIG. 8. Shows the bottom of the top bracket device with clips that are made so the trashcan device can slide Un easy to inter lock.

FIG. 9. Shows the direction to push up and twist the device into the top device causing them to inter lock and stay fasten to each other.

Twisting the device the other direction loosen it to install refills.

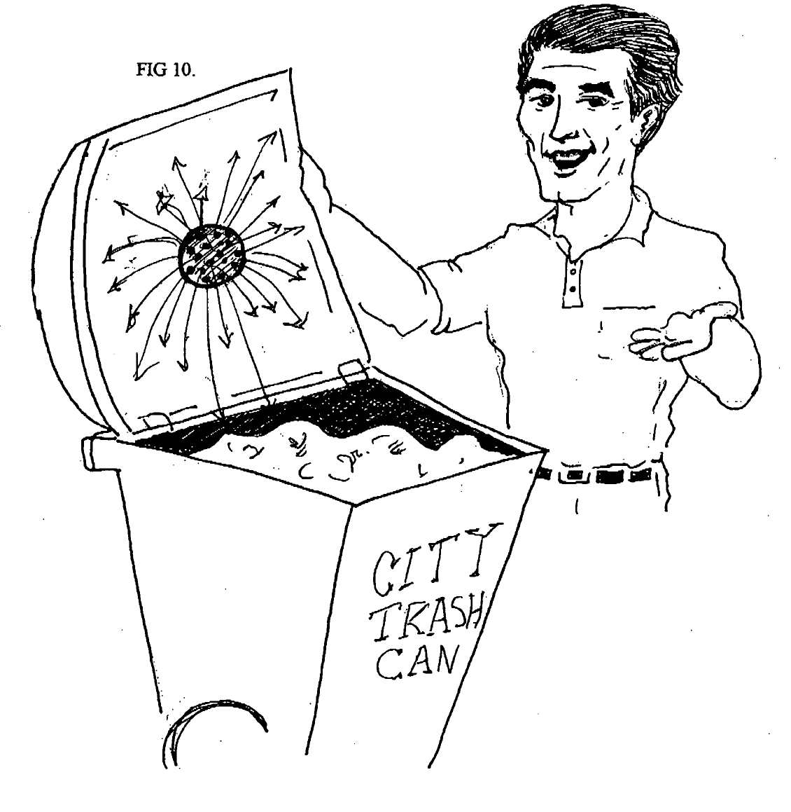

FIG. 10. Shows a drawing on how the “TRASHCAN AND DUMPSTER PEST ELIMINATOR” attaches to ones trashcan top and making it a gas chamber for the germ and disease carrying insects.

1. What I claim as my invention is the “Trashcan and Dumpster Pest Eliminator.”
